(19) United States
(12) Patent Application Publication
(10) Pub. No.: US 2007/0090086 A1
(43) Pub. Date: Apr. 26, 2007

(54) Two-layer flexible printed wiring board and method for manufacturing the two-layer flexible printed wiring board

(75) Inventors: Makoto Yamagata, Tokyo (JP); Hiroaki Kurihara, Tokyo (JP); Naoya Yasui, Tokyo (JP); Noriaki Iwata, Tokyo (JP)

Correspondence Address: THE WEBB LAW FIRM, P.C., 700 KOPPERS BUILDING, 436 SEVENTH AVENUE, PITTSBURGH, PA, 15219, US

(73) Assignee: Mitsui Mining & Smelting Co., Ltd., Shinagawa-ku (JP)

(21) Appl. No.: 11/585,679

(22) Filed: Oct. 24, 2006

(30) Foreign Application Priority Data
Oct. 25, 2005 (JP) 2005-310549

(51) Int. Cl. H01B 13/00; B32B 3/00; B32B 7/00

(52) U.S. Cl. 216/13; 428/209; 428/901

(57) ABSTRACT

An object of the present invention is to provide a flexible printed wiring board, excellent in folding ability, obtained from a flexible copper-clad laminate using an electro-deposited copper foil. In order to achieve the object, there is provided a two-layer flexible printed wiring board having a wiring, formed by etching an electro-deposited copper foil, on a surface of a resin film layer, the wiring including only a steady-deposition crystal layer 2 formed by removing an initial-deposition crystal layer 1 formed at the time of the electro-deposited copper foil preparation. When the two-layer flexible printed wiring board has a cover film layer, preferably the deviation between the neutral line of the sectional thickness of the two-layer flexible printed wiring board and the central line of the wiring thickness of the two-layer flexible printed wiring board falls within 5% of the total thickness of the two-layer flexible printed wiring board.

### BACKGROUND OF THE INVENTION

1. Field of the Invention

The present invention relates to a two-layer flexible printed wiring board and a method for manufacturing the two-layer flexible printed wiring board. In particular, the present invention relates to a two-layer flexible printed wiring board in which an electro-deposited copper foil characterized by having a low profile deposition surface is used for forming the wiring of the two-layer flexible printed wiring board, and which is required to enable fine wiring including COF (Chip on film) and to have a high folding endurance.

1. Description of the Related Art

Recent electronic and electric devices using printed wiring boards for various purposes have been required to be downsized and reduced in weight, namely, to be made light in weight, thin in thickness and small in size. Under these circumstances, the components to be mounted inside these devices have also been limited in areas available for mounting thereof, and printed wiring boards as electronic components have also been required to be downsized through forming high-density wirings and additionally to be easily adaptable to surface mounting.

As electronic and electric devices have been downsized, for the purpose of mounting printed wiring boards in small areas in such devices, printed wiring boards have also been required to have folding ability to allow bending distortion for mounting or to have workability including the usability thereof as printed wiring boards as they remain bent. Accordingly, rigid substrates typified by a glass-epoxy resin base material and the like cannot be used because of lack of folding ability; flexible printed wiring boards using as base materials (base films) polyimide resin film, PET resin film, aramid resin film and the like have been used for various purposes.

Such flexible printed wiring boards are most prominently characterized by sufficient folding ability, as described above, and accordingly are inserted in the interior of electronic and electric devices as they are distorted by bending, and used at positions undergoing repeated bending. Such flexible printed wiring boards are generally obtained by etching flexible copper clad laminates in each of which a copper foil is laminated on a base film; as a copper foil for such a case, either of an electro-deposited copper foil and a rolled copper foil has been used. However, as disclosed in Patent Document 1, in consideration of the durability against repeated occurrence of bending distortion, a rolled copper foil has been regarded as preferable to an electro-deposited copper foil because of the characteristics of the crystal structures originating from the preparation methods therefor.

On the other hand, even among flexible printed wiring boards each obtained by etching a flexible copper clad laminate the copper layer of which has been formed by use of an electro-deposited method, there are those flexible wiring boards that have been developed to attain higher folding endurance than those using conventional electro-deposited copper foils. Specifically, as disclosed in Patent Document 2, such highly flexible wiring boards are those obtained by adopting a metallizing method in which a thin seed layer is formed on the surface of a base film such as a polyimide resin film by means of sputtering deposition or the like, and then a copper layer or the like is formed on the seed layer in a predetermined thickness by an electro-deposited method. The metallizing method can form the conductive layer so as to have a thin and uniform thickness because of the nature of such a production method, and hence is suitable for fine pitch wiring formation; the folding endurance of a flexible printed wiring board using such an electro-deposited copper foil is said to approach the performance of a flexible printed wiring board using a rolled copper foil.

On the other hand, from the viewpoint of the fine pitch wiring formation, a fine wiring formation of a wiring pitch of 35 μm or less is regarded as extremely difficult; thus, an attempt has been made to make the roughness of the deposition surface of an electro-deposited copper foil closer to the roughness of the shiny surface of the electro-deposited copper foil; thus, the provision of such low profile electro-deposited copper foils as disclosed in Patent Documents 3 and 4 has been investigated. The electro-deposited copper foils disclosed in this Patent Document each have an excellent low-profile deposition surface (hereinafter referred to as “deposition surface” as the case may be) formed thereon, and exhibit extremely excellent etching performance as low-profile electro-deposited copper foils; thus, the use of such electro-deposited copper foils as constituent materials for flexible copper clad laminates enhances the possibility that fine-pitch flexible printed wiring boards incorporating wirings of 35 μm or less in pitch are manufactured in high process provide and can be provided.

The above-mentioned patent documents are: Patent Document 1 (Japanese Patent Laid-Open No. 2001-15876), Patent Document 2 (Japanese Patent Laid-Open No. 2003-334890), Patent Document 3 (Japanese Patent Laid-Open No. 2004-35918), and Patent Document 4 (Japanese Patent Laid-Open No. 2004-107786).

However, if rolled copper foils are considered to be used as fundamental materials for flexible printed wiring boards, rolled copper foils are higher in price than electro-deposited copper foils, and hence there is a limit to the extent that benefits are brought to consumers by lowering prices of products.

When the copper layer of a flexible copper clad laminate is formed by the above-mentioned metallizing method, the interface between the base film layer and the wiring is flat and smooth, and hence the formation of a fine-pitch wiring as a flexible printed wiring board is easy to carry out; however, there is a problem that the adhesiveness between the base film and the wiring is low and hence the usable range thereof is limited.

Further, also as for the use of an electro-deposited copper foil allowing fine-pitch wiring formation, recent flat display panels (LCD panels, plasma display panels and the like) have undergone rapid progress in increasing the screen size. The shift to the terrestrial digital broadcasting, together with the screen size increase, goes with the high definition of images based on hi-vision. Consequently, electronic circuits and printed wiring boards are also required to be downsized and sophisticated, and wiring is naturally required to attain a higher level of fine pitch. For the drivers for such flat display panels as mentioned above, generally used are the above-mentioned tape automated bonding substrates (three-layer TAB tapes) and chip-on-film substrates (COF tapes); for the purpose of realizing high-vision monitors, the above-mentioned drivers are also required to involve finer wiring formation.

As can be seen from the above-mentioned circumstances, the market has demanded flexible printed wiring boards obtained from flexible copper clad laminates that use electro-deposited copper foils as inexpensive materials, in particular, the products excellent in folding ability. For such flexible printed wiring boards, there has been a demand for low-profile and high-strength electro-deposited copper foils allowing the wiring formation finer in pitch than the wiring obtainable by using low-profile electro-deposited copper foils that have hitherto been supplied in the market.

### SUMMARY OF THE INVENTION

Under these circumstances, as a result of a diligent study, the present inventors have thought up an idea that by adopting a technical idea to be described below, even a two-layer flexible printed wiring board using an electro-deposited copper foil can attain a high folding ability equivalent to or higher than the folding ability of a two-layer flexible printed wiring board obtained by etching a two-layer flexible copper clad laminate having a copper layer formed by the metallizing method. Hereinafter, the contents of the present invention will be described.

The two-layer flexible printed wiring board according to the present invention is a two-layer flexible printed wiring board having a wiring, formed by etching an electro-deposited copper foil, on a surface of a resin film layer, the wiring including only a steady-deposition crystal layer formed by removing an initial-deposition crystal layer formed at the time of the electro-deposited copper foil preparation.

When the two-layer flexible printed wiring board according to the present invention is a two-layer flexible printed wiring board having a cover film layer, the deviation between the neutral line of the sectional thickness of the two-layer flexible printed wiring board and the central line of the wiring thickness of the two-layer flexible printed wiring board is preferably made to fall within 5% of the total thickness of the two-layer flexible printed wiring board.

When the two-layer flexible printed wiring board according to the present invention is a two-layer flexible printed wiring board having a solder resist layer, the deviation between the neutral line of the sectional thickness of the two-layer flexible printed wiring board and the central line of the wiring thickness of the two-layer flexible printed wiring board is preferably 20% to 30% of the total thickness of the two-layer flexible printed wiring board.

Further, among two-layer flexible printed wiring boards, the two-layer flexible printed wiring board according to the present invention is easily converted into a film carrier tape-shaped two-layer flexible printed wiring board in which the formed wiring has a fine-pitch wiring of 35 μm or less in pitch.

A method for manufacturing the two-layer flexible printed wiring board according to the present invention: As a method for manufacturing the above-mentioned two-layer flexible printed wiring board, there is provided a method for manufacturing a two-layer flexible printed wiring board, in which a two-layer flexible printed wiring board is manufactured by etching a two-layer flexible copper clad laminate formed by laminating a resin film layer and an electro-deposited copper foil, the manufacturing method including the following steps A to C:

Step A: a step of forming a flexible copper clad laminate by providing a resin film layer on the deposition surface of an electro-deposited copper foil having a shiny surface and a deposition surface on the front side and the back side thereof, respectively;

Step B: a step of removing an initial-deposition crystal layer of the electro-deposited copper foil by half-etching the shiny surface of the electro-deposited copper foil located on the surface of the above-mentioned flexible copper clad laminate to expose a steady-deposition crystal layer of the electro-deposited copper foil; and

Step C: a step of forming a wiring by forming an etching resist layer on the steady-deposition crystal layer, exposing and developing an etching resist pattern, carrying out wiring etching, and stripping the etching resist to provide a two-layer flexible printed wiring board.

The half etching in the step B removes the initial-deposition crystal layer, and also preferably regulates the thickness of the electro-deposited copper foil layer until the deviation between the neutral line of the sectional thickness of the flexible printed wiring board to be formed and the central line of the sectional thickness of the electro-deposited copper foil layer falls within a predetermined range.

It is also preferable to provide a method for manufacturing the two-layer flexible printed wiring board, in which a two-layer flexible printed wiring board is manufactured by etching a two-layer flexible copper clad laminate formed by laminating a resin film layer and an electro-deposited copper foil, the manufacturing method including the following steps a to c:

Step a: a step of removing an initial-deposition crystal layer by half-etching from the side of the shiny surface of an electro-deposited copper foil having a shiny surface and a deposition surface on the front side and the back side thereof, respectively;

Step b: a step of forming a two-layer flexible copper clad laminate by providing a resin film layer on the shiny surface from which the initial-deposition crystal layer has been removed; and

Step c: a step of forming a wiring by forming an etching resist layer on the deposition surface of the electro-deposited copper foil located on a surface of the flexible copper clad laminate, exposing and developing an etching resist pattern, carrying out wiring etching, and stripping the etching resist to provide a two-layer flexible printed wiring board.

The half etching in the step a removes the initial-deposition crystal layer, and also preferably regulates the thickness of the electro-deposited copper foil layer until the deviation between the neutral line of the sectional thickness of the flexible printed wiring board to be formed and the central line of the sectional thickness of the electro-deposited copper foil layer falls within a predetermined range.

The above-mentioned electro-deposited copper foil to be used for the wiring formation in the two-layer flexible printed wiring board according to the present invention is preferably an electro-deposited copper foil having a deposition surface which is a low-profile shiny surface having a surface roughness (Rzjis) of 1.5 μm or less and a glossiness (Gs(60°)) of 400 or more.

For the above-mentioned electro-deposited copper foil to be used for the wiring formation in the two-layer flexible printed wiring board according to the present invention, preferably used is an electro-deposited copper foil having an tennsile strength as received of 33 kgf/mm² or more and a tensile strength after heating (180° C.×60 min in the ambient atmosphere) of 30 kgf/mm² or more.

Further, for the above-mentioned electro-deposited copper foil to be used for the wiring formation in the two-layer flexible printed wiring board according to the present invention, preferably used is an electro-deposited copper foil having an elongation as received of 5% or more and an elongation after heating (180° C.×60 min in the ambient atmosphere) of 8% or more.

For the above-mentioned electro-deposited copper foil to be used for the wiring formation in the two-layer flexible printed wiring board according to the present invention, preferably used is an electro-deposited copper foil which is obtained by electrolyzing a sulfuric acid-containing copper electro-deposited solution containing diallyldimethylammonium chloride as a quaternary ammonium salt polymer.

For the above-mentioned electro-deposited copper foil to be used for the wiring formation in the two-layer flexible printed wiring board according to the present invention, also preferably used is an electro-deposited copper foil having a deposition surface subjected to at least one surface treatment of a roughening treatment, an passivation treatment and a silane coupling agent treatment.

The above-mentioned electro-deposited copper foil is preferably an electro-deposited copper foil having a low profile deposition surface having a surface roughness (Rzjis) of 5 μm or less even after the above-mentioned surface treatment.

The two-layer flexible printed wiring board according to the present invention has a characteristic that the initial-deposition crystal layer formed at the time of the electro-deposited copper foil preparation is removed from the wiring surface of the two-layer flexible printed wiring board and the steady-deposition crystal layer is thereby exposed. Owing to the presence of this characteristic, the concerned two-layer flexible printed wiring board exhibits a folding endurance equivalent to or higher than the folding endurance of a case where a usual electro-deposited copper foil for a flexible printed wiring board is used, and comes to exhibit a folding endurance equivalent to or higher than the folding endurance of a two-layer flexible printed wiring board in which a wiring formation is carried out by etching a copper layer formed by the metallizing method. By using the above-mentioned low-profile electro-deposited copper foil in the manufacture of the two-layer flexible printed wiring board according to the present invention, it becomes possible to improve the folding endurance and it also becomes possible to easily obtain a two-layer flexible printed wiring board having a wiring of 35 μm or less in pitch. Consequently, among two-layer flexible printed wiring boards, the two-layer flexible printed wiring board according to the present invention is suitable for use in such boards as chip-on-film (COF) boards known as tape-shaped products and having fine leads.

### BRIEF DESCRIPTION OF THE DRAWINGS

FIG. 1 shows transmission electron microscope (TEM) observation images of a section of an electro-deposited copper foil subjected to sputtering by using a focused secondary ion-beam processing apparatus (FIB);

FIG. 2 is a schematic diagram illustrating an MIT type folding endurance tester;

FIG. 3 is a schematic diagram showing a specimen for the folding endurance testing measurement;

FIG. 4 is a schematic diagram illustrating the relation between the neutral line of the section of a flexible printed wiring board having a cover film layer and the central line of the thickness of the electro-deposited copper foil of the flexible printed wiring board;

FIG. 5 is a schematic diagram showing a model illustrating the distortion generation occurring when the flexible printed wiring board having a cover film layer is folded; and

FIG. 6 is a schematic diagram illustrating the relation between the neutral line of the section of a flexible printed wiring board having a solder resist layer and the central line of the thickness of the electro-deposited copper foil of the flexible printed wiring board.

### DETAILED DESCRIPTION OF THE PREFERRED EMBODIMENTS

Hereinafter, description will be made on the embodiments of the flexible printed wiring board according to the present invention and the manufacturing embodiments of the printed wiring boards.

The form of the flexible printed wiring board according to the present invention: The flexible printed wiring board according to the present invention is a two-layer flexible printed wiring board having a wiring, formed by etching an electro-deposited copper foil, on the surface of a resin film, and is not different from conventional flexible printed wiring boards as far as the fundamental configuration is concerned. The flexible printed wiring board according to the present invention is technically characterized in that the concerned wiring involves only the steady-deposition crystal layer through removal of the initial-deposition crystal layer formed at the time of the electro-deposited copper foil preparation. The two-layer flexible printed wiring board as referred to herein means a type in which no adhesive layer is interposed between the wiring and the resin film layer, and hereinafter in the present specification, will be simply referred to as the “flexible printed wiring board.” Specifically, the wiring of the flexible printed wiring board as referred to herein is a wiring manufactured with an electro-deposited copper foil as a starting material, and means that the concerned wiring has only to satisfy the condition that no initial-deposition crystal layer remains in the wiring formed by etching the electro-deposited copper foil. In other words, when an electro-deposited copper foil has no initial-deposition crystal layer, a resin film layer can be provided on either of both surfaces thereof.

The flexible printed wiring board as referred to herein is described so as to include flexible printed wiring boards, to which all the processing methods well known in the art are applied before and/or after the wiring formation according to the applications of the flexible printed wiring boards, such as a flexible printed wiring board having a cover film on the surface layer of the wiring, a flexible printed wiring board having a solder resist layer on the wiring without having a cover film and a flexible printed wiring board having a plating layer such as a tin, solder or gold plating layer formed on the wiring after the wiring formation.

Description will be made on the initial-deposition crystal layer and the steady-deposition crystal layer. At the beginning, description is made on a general method for manufacturing an electro-deposited copper foil. For an electro-deposited copper foil, generally a continuous production method is adopted; a copper sulfate based solution is made to flow between a drum-shaped rotary cathode and an insoluble anode (DSA) disposed so as to face the cathode along the shape of the cathode, copper is electro-deposited on the drum surface of the rotary cathode by means of an electro-deposited reaction, the copper thus electro-deposited takes a state of foil, and the copper in a state of foil is continuously peeled off from the rotary cathode and taken up to manufacture an electro-deposited copper foil.

The electro-deposited copper foil surface peeled off from the state of being in contact with the rotary cathode has a shape transferred from the mirror finished surface of the rotary cathode, and is referred to as a shiny surface because it is a shiny and smooth surface although there are some irregularities. On the contrary, the shape of surface that has been the deposition side exhibits mountain-shaped irregularities because of the rate variation of the crystal growth of the electro-deposited copper depending on the crystal planes, and hence this surface is referred to as a deposition surface or a deposition surface (hereinafter in the present specification, the term “deposition surface” being used). The deposition surface concerned serves as the surface to be adhered to an insulating layer when the copper clad laminated is manufactured. The smaller is the roughness of the deposition surface, the electro-deposited copper foil is said to be the better low-profile electro-deposited copper foil. However, in the manufacturing of the flexible printed wiring board according to the present invention, the roughness of the deposition surface is smoother than the shiny surfaces of the copper foils manufactured by using common electrolysis drums, and hence the term, deposition surface, will not be used, but the term “deposition surface” will be used.

The copper deposition process at the time of electrolysis may be described as follows. When an electrolysis current is made to flow, at the beginning copper embryos (buds) are formed on the surface of the rotary cathode. The embryos gradually grow to form fine initial-deposition crystals each having a preferential deposition crystal surface on the surface layer thereof to form an initial-deposition crystal layer having a certain thickness. Subsequently, when the electrolysis is continued, the copper deposition surface gets closer to the anode surface, or steady-deposition crystals, larger in particle size than the initial-deposition crystals, come to cover the whole surface by reflecting a slight variation in the electrolysis conditions such as activated stirring effects caused by the oxygen generated by electrolysis or the like. Consequently, the layer configuration of the electro-deposited copper foil can be said to be composed of two layers, namely, the initial-deposition crystal layer and the steady-deposition crystal layer according to a strict consideration on the crystal structure. The thickness of the initial-deposition crystal layer varies depending on the electrolysis conditions for manufacturing the electro-deposited copper foil including the type of the electrolysis solution, the current density, the electrode materials and the surface conditions of the electrodes. Accordingly, it is clearly stated that the thickness of the initial-deposition crystal layer should be judged according to the types of the commercially available electro-deposited copper foils.

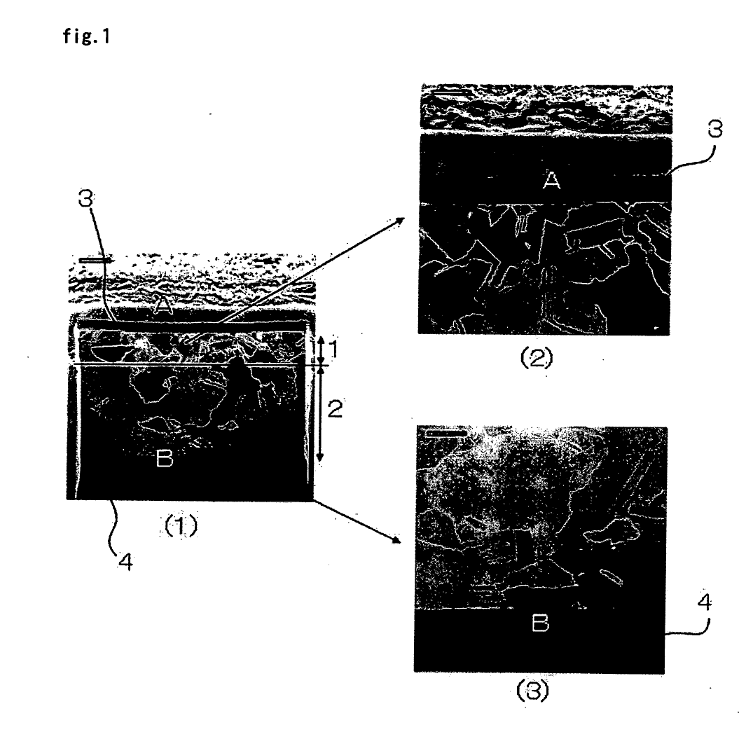

FIG. 1 shows transmission electron microscope (TEM) observation images of a section of an electro-deposited copper foil subjected to sputtering by using a focused secondary ion-beam processing apparatus (FIB); FIG. 1(1) shows an image of a magnification of 8000. In FIG. 1(1), the side denoted by “A” is the shiny surface side of the electro-deposited copper foil, namely, the side on which the initial-deposition crystal layer 1 emerges on the surface layer. In FIG. 1(1), the layer observed as a black layer on the initial-deposition crystal layer is a so-called solder resist layer 3, and outside the solder resist layer is an embedding material for observation of the section. On the other hand, in FIG. 1(1), the side denoted by “B” is the deposition surface side of the electro-deposited copper foil, namely, the side on which the steady-deposition crystal layer 2 emerges on the surface layer. In FIG. 1(1), the layer observed as a black layer beneath the steady-deposition crystal layer is a polyimide resin film layer

FIG. 1(2) shows the enlarged images of the crystals of the initial-deposition crystal layer in a magnification of 20000, and FIG. 1(3) shows the enlarged images of the crystals of the steady-deposition crystal layer in a magnification of 20000. As can be seen from a comparison between FIG. 1(2) and FIG. 1(3), coarse crystal grains are observed in the crystals of the steady-deposition crystal layer, but no coarse crystal grains are identified in the crystal structure of the initial-deposition crystal layer, the crystal structure seemingly having a state that the crystal grains are fine and the variation of the crystal grain size is rather small. Consequently, from a metallurgical viewpoint, the mechanical strength is increased by reducing the crystal grain size, and with respect to the resistance to the sliding distortion of the crystal plane, the initial-deposition crystal layer having fine and uniform crystals is seemed to be superior to the steady-deposition crystal layer.

However, for the purpose of actually estimating the folding endurance, a folding endurance test has been attempted to definitely find that microcracks are generated in the wiring in the course of the folding endurance test with a higher possibility from the side of the initial-deposition crystal layer. This is conceivably caused by the following reason. When the electro-deposited copper foil is subjected to repeated folding distortion, the portion subjected to folding distortion undergoes progressive work hardening naturally because the electro-deposited copper foil is a metallic material. When a work hardening phenomenon is generated in a portion, the dislocation density in that portion is increased to result in a hardening to increase the strength, but the elongation is decreased and the followability to the flex distortion is degraded. In other words, the difference between the crystal structure constituting the initial-deposition crystal layer and the crystal structure constituting the steady-deposition crystal layer conceivably resides in the fact that the dislocation density involved in the interior of the crystals constituting the initial-deposition crystal layer is higher than the dislocation density of the steady-deposition crystal layer. Accordingly, as can be inferred, when a portion undergoes repeated folding distortion, the progress of the work hardening in the initial-deposition crystal layer is faster than the progress of the work hardening in the steady-deposition crystal layer, consequently microcracks are generated from the grain boundary in the initial-deposition crystal layer and the propagation of the microcracks occurs along the thickness direction to lead to a fracture of the electro-deposited copper foil (wiring fracture).

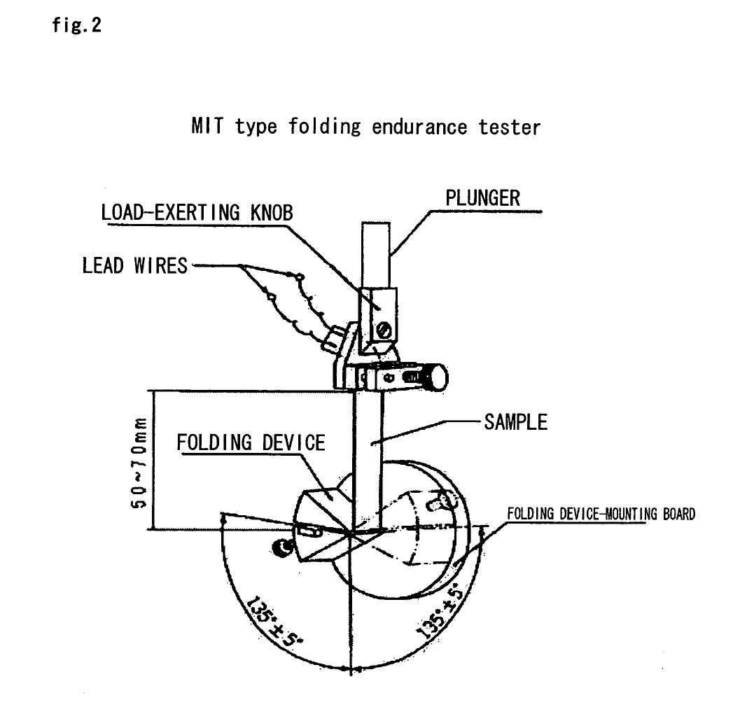

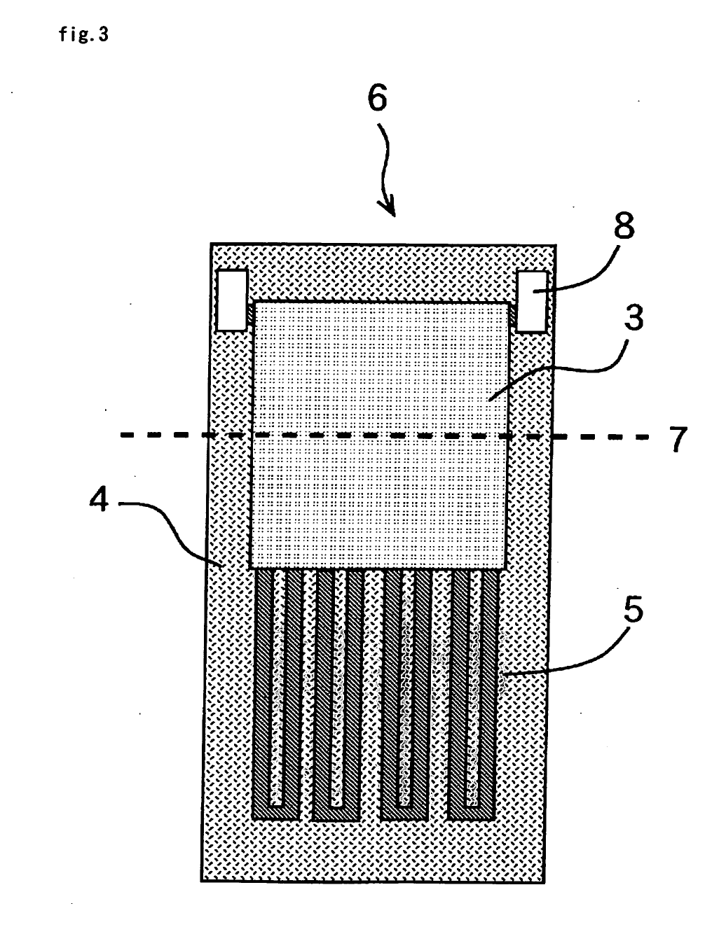

Now, description is made on the folding endurance test that has been performed in the present invention. Here, an MIT type folding endurance tester (conduction system) shown in FIG. 2 was used; the adopted conditions were such that the load was 100 gf, the folding rate was 175 times/min, the folding radius was 0.5 mm or 0.8 mm (double conditions) and the swing angle (between right and left) was 135°; and the test was continued until the fracture of the copper foil occurred. The samples 6 used for the measurement were prepared as shown in FIG. 3, wherein a wiring (a copper layer) 5 was formed on a polyimide resin film layer 4, and further a solder resist layer 3 was formed; and a predetermined number of times of folding (repeated folding) was carried out at the folding position 7 (the position where the solder resist layer 3 was present), and the fracture conditions of the wiring (copper layer) 5 were identified.

As described above, the flexible printed wiring board according to the present invention can remarkably improve the folding endurance by removing the initial-deposition crystal layer from the surface of the wiring to leave only the steady-deposition crystal layer.

Further, the folding endurance is stabilized and improved when the deviation between the neutral line of the sectional thickness of the flexible printed wiring board and the central line of the wiring thickness of the flexible printed wiring board falls within a certain range in relation to the total thickness of the flexible printed wiring board. The appropriate range of the deviation is different between the case where a cover film is provided on the wiring and the case where a solder resist layer is provided on the wiring (without the cover film).

In other words, in the former case with a cover film, the deviation between the neutral line of the sectional thickness of the flexible printed wiring board and the central line of the wiring thickness of the flexible printed wiring board falls preferably within 5% and more preferably within 3% of the total thickness of the flexible printed wiring board. On the other hand, in the case where having a solder resist layer, the deviation between the neutral line of the sectional thickness of the flexible printed wiring board and the central line of the wiring thickness of the flexible printed wiring board is preferably 20% to 30% of the total thickness of the flexible printed wiring board. By virtue of designing of such flexible printed wiring boards, more stable folding endurances are exhibited. It is to be noted that the term, wiring thickness, as referred to herein is used to definitely state that this thickness includes the plating layer thickness when the copper layer is subjected to etching to form a wiring and then a tin plating, a copper plating or the like is applied.

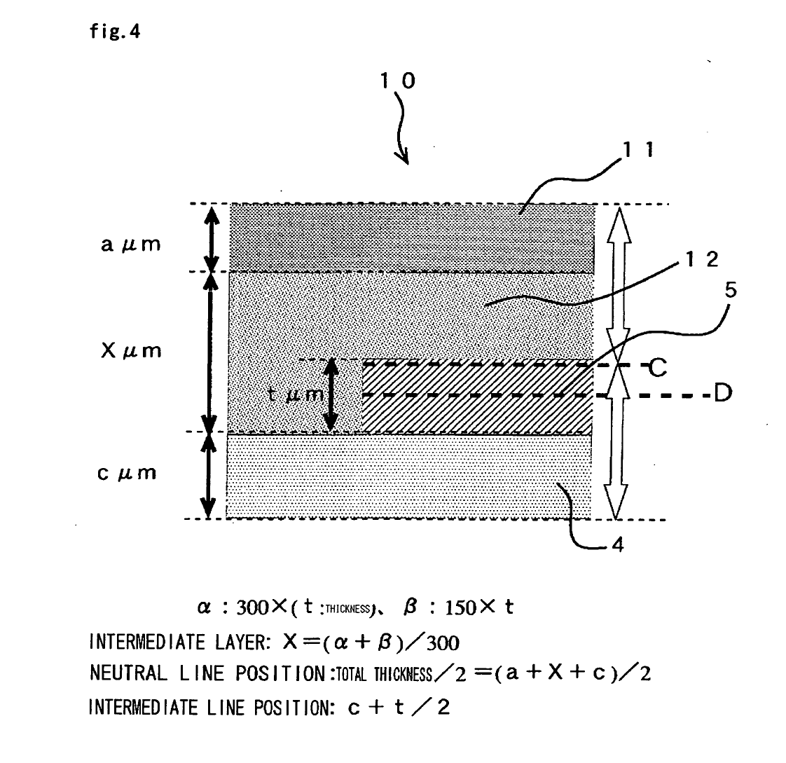

Now, with reference to FIG. 4, description is made on how to make appropriate the relation between the neutral line of the section of a flexible printed wiring board having a cover film and the central line of the thickness of the electro-deposited copper foil of the flexible printed wiring board. In a schematic presentation of the section of a flexible printed wiring board 10, a cover film 11, a cover adhesive layer 12, a wiring (copper layer) 5 and a polyimide resin film 4 are disposed in a laminated manner. The neutral line C of the sectional thickness of the flexible printed wiring board 10 is represented by a dashed line, and the central line D of the wiring thickness is represented by a dash-dot line.

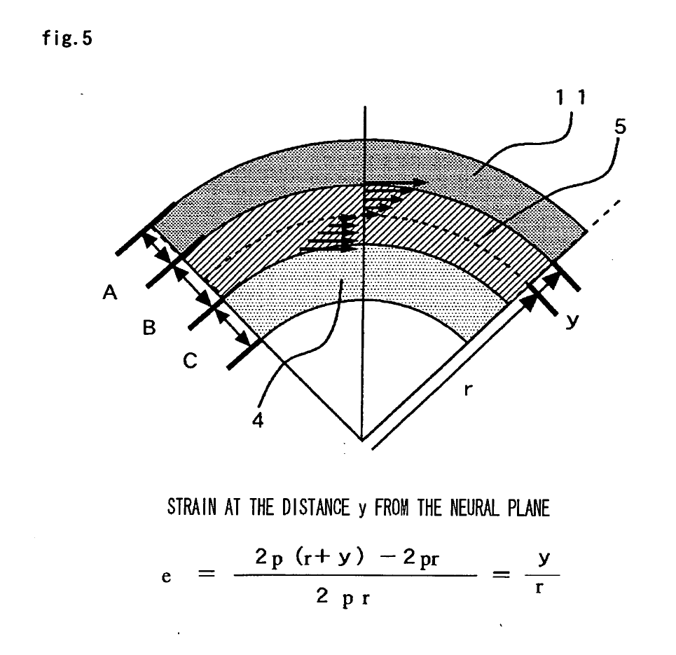

FIG. 5 shows a model illustrating the distortion generation occurring in a section of a flexible printed wiring board when it is folded. Because the distortion level is determined by the formula presented in FIG. 5, both of the tensile stress and the compression stress become larger as the distance from the above-mentioned neutral line C is increased. Accordingly, when only the prevention of the interfacial peeling between the wiring 5 and the cover adhesive layer 12 is considered, conceivably it is most effective to make the neutral line coincide with the concerned interface. However, in order to form such a state, the thickness of the cover film is unpractically made large, so that the strain generated on the copper foil surface adhering to the polyimide resin film becomes extremely large, and a risk of generation of microcracks from the copper foil surface in contact with the polyimide resin film becomes high. Accordingly, in consideration of the total performance of a flexible printed wiring board, it provides an ideal state to make the neutral line C of the sectional thickness of the flexible printed wiring board coincide with the central line D of the thickness of the electro-deposited copper foil of the flexible printed wiring board. As a result of a study carried out according to this logic, the flexible printed wiring board according to the present invention exhibits an extremely satisfactory and stable folding endurance if the deviation between the neutral line of the sectional thickness of the flexible printed wiring board and the central line of the wiring thickness of the flexible printed wiring board falls within the above-mentioned range.

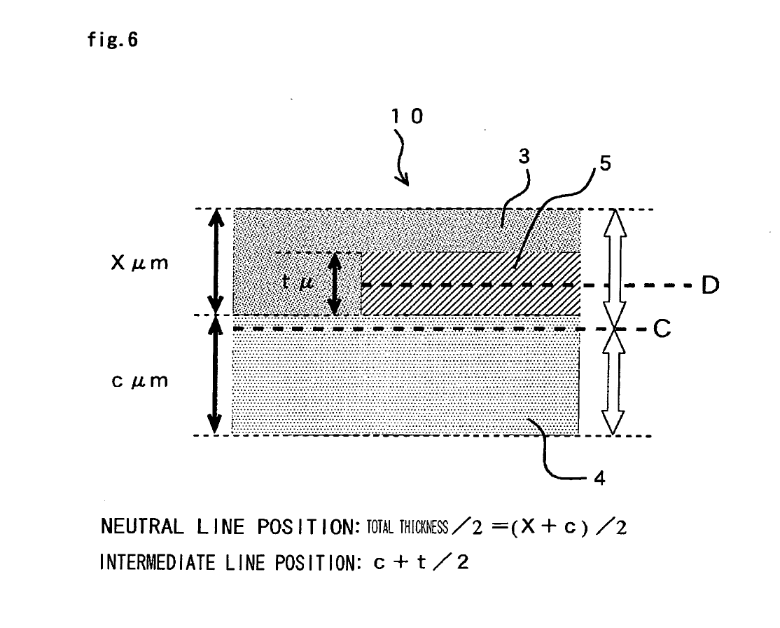

There is a case where the two-layer flexible printed wiring board according to the present invention is a two-layer flexible printed wiring board having no cover film but having a solder resist layer. Two-layer flexible printed wiring boards having such a layer configuration are used as film tape carriers for various purposes; when used as film tape carriers, it is a regular way to set the thickness of the resin layer to fall within the range from 30 μm to 45 μm. Accordingly, the deviation between the neutral line of the sectional thickness of the two-layer flexible printed wiring board and the central line of the wiring thickness of the flexible printed wiring board is needed to be considered by taking account of the thickness of the above-mentioned resin film layer as a prerequisite. Consequently, it has been found that in the case of the concerned two-layer flexible printed wiring board in which the wiring formation is carried out by use of an electro-deposited copper foil, an extremely satisfactory and stable folding endurance is exhibited when the deviation between the neutral line of the sectional thickness thereof and the central line of the wiring thickness thereof is 20% to 30% and more preferably 22% to 27% of the total thickness of the two-layer flexible printed wiring board. In this connection, when the deviation between the neutral line of the sectional thickness of the two-layer flexible printed wiring board and the central line of the wiring thickness of the two-layer flexible printed wiring board is less than 20%, the thickness of the wiring is meant to become thin in relation to the resin film layer, and hence component mounting becomes difficult in applications of the tape carrier films such as COFs in which the layer configuration of the two-layer flexible printed wiring board is used for various purposes. On the other hand, when the concerned deviation exceeds 30%, the wiring surface is separated too far from the position of the neutral line, the distortion magnitude of the wiring surface at the time of folding becomes large to facilitate the generation of microcracks. FIG. 6 shows a schematic diagram illustrating the section of a flexible printed wiring board having a solder resist layer 3 (it is possible to have a plating layer on the wiring; however, in that case, the plating layer may be considered as a part of the wiring, and hence the depiction of the plating layer is omitted in the figure). As can be seen from a comparison between FIG. 6 and FIG. 4, the layer configuration of FIG. 6 is regarded as the state of FIG. 4 from which the adhesive layer is omitted. Accordingly, the same idea as applied to the case where a cover film is provided can be adopted, and an ideal state is provided by making the neutral line C of the sectional thickness of the flexible printed wiring board coincide with the central line D of the thickness of the electro-deposited copper foil of the flexible printed wiring board; however, it is a prerequisite that the resin film layer falls within the above-mentioned range, and from the viewpoint of the board design, it is difficult to make the neutral line of the sectional thickness of the flexible printed wiring board having a solder resist layer perfectly coincide with the central line of the wiring thickness of the flexible printed wiring board. However, when the concerned deviation falls within the above-mentioned range, an extremely satisfactory and stable folding endurance is exhibited.

No particular constraint is imposed on the thickness of the electro-deposited copper foil as referred to herein. According to the fineness level of the wiring to be formed, the electro-deposited copper foil can be appropriately selectively used. The electro-deposited copper foil as referred to in the present invention has no particular constraint imposed on the thickness thereof, and preferably the electro-deposited copper foils exhibiting the elongation property of class 3 or higher as specified by IPC-MF-150F are selectively used.

Manufacturing embodiment of the flexible printed wiring board according to the present invention: Preferably, any of the following two manufacturing methods can be selectively used as the method for manufacturing the above-mentioned flexible printed wiring boards.

A first manufacturing method is a manufacturing method to be applied to the case where the deposition surface of an electro-deposited copper foil is used as a surface for adhering to a resin film layer. More specifically, the concerned manufacturing method is a method for manufacturing a flexible printed wiring board by etching a flexible copper clad laminate formed by laminating a resin film layer and an electro-deposited copper foil, and adopts a manufacturing method characterized by including the following steps A to C. Here, it is to be clearly stated that these manufacturing steps may be carried out each as an independent batch process, or may be carried out in a continuous manufacturing line in which a sequence of steps are continuously arranged as in the manufacturing of film carrier tape products.

Step A: This step of forming a laminate is a step in which a two-layer flexible copper clad laminate is formed by forming a resin film layer on the deposition surface of an electro-deposited copper foil having a shiny surface and a deposition surface on the front side and the back side thereof, respectively. As described above, for an electro-deposited copper foil, generally a continuous production method is adopted; a copper sulfate based solution is made to flow between a drum-shaped rotary cathode and an anode disposed so as to face the cathode along the shape of the rotary cathode, copper is electro-deposited on the drum surface of the rotary cathode, the copper thus electro-deposited takes a state of foil, and the copper in a state of foil is continuously peeled off from the rotary cathode and taken up to manufacture an electro-deposited copper foil. At this stage, no surface treatment such as an passivation treatment is made, and the copper immediately after the electrode position is in a very activated state, namely in a state to be easily oxidized by the oxygen in the air.

The electro-deposited copper foil surface peeled off from the state of being in contact with the rotary cathode has a shape transferred from the mirror finished surface of the rotary cathode, and has been referred to as a shiny surface because it is a shiny and smooth surface. On the contrary, the shape of the surface that has been the deposition side exhibits mountain-shaped irregularities because of the crystal growth rate variation of the electro-deposited copper depending on the crystal planes, and hence this surface is referred to as a deposition surface or a deposition surface (hereinafter in the present specification, the term “deposition surface” is used) The smaller is the roughness of the deposition surface, the electro-deposited copper foil is said to be the better low-profile electro-deposited copper foil. In the manufacturing of the two-layer flexible printed wiring board according to the present invention, sometimes there are used electro-deposited copper foils in which the roughness of the deposition surface is smoother than the shiny surfaces of the copper foils manufactured by using common electrolysis drums, and hence the term, deposition surface, is not used, but simply the term “deposition surface” is used.

As described above, the electro-deposited copper foil immediately after being obtained by electrolysis is a product in a state of being subjected to no surface treatment, and hence is sometimes distinguished under the name of “untreated copper foil,” “segregated foil” or the like. However, in the present specification, simply the term, “electro-deposited copper foil,” is used on the basis of the generally accepted notion used in the market, irrespective as to whether or not a roughening treatment or a surface treatment, to be described below, is applied.

In a surface treatment process, the above-mentioned electro-deposited copper foil (untreated copper foil) is subjected to treatments such as a roughening treatment and an passivation treatment of the deposition surface (the shiny surface may also be treated, as the case may be). The roughening treatment of the deposition surface means a treatment in which, in general, fine copper particles are electro-deposited on the deposition surface in an aqueous solution of copper sulfate, and if needed, a coating plating is made within a current range in conformity with the smooth plating conditions, and thus the exfoliation of the fine copper particles is prevented. Accordingly, the deposition surface on which fine copper particles have been electro-deposited is referred to as a “roughened surface.” Successively, in the surface treatment process, an passivation treatment is applied onto the front and back sides of the electro-deposited copper foil, by means of a plating with zinc, an zinc alloy or a chromium-based material, an organic passivation treatment or the like. The electro-deposited copper foil thus treated is dried and taken up to be completed as a surface-treated electro-deposited copper foil. It is to be clearly noted that only an passivation treatment is applied without applying a roughening treatment, as the case may be.

When a low-profile electro-deposited copper foil is used for the electro-deposited copper foil to be used here, it is preferable to use an electro-deposited copper foil having the following characteristics. Specifically, used is an electro-deposited copper foil having a low-profile deposition surface in which the surface roughness (Rzjis) is 1.5 μm or less, preferably 1.2 μm or less and more preferably 1.0 μm or less, and the glossiness (Gs(60°)) is 400 or more, the deposition surface and the resin film being adhered to each other to be used. The use of such a low-profile copper foil in a two-layer flexible printed wiring board makes it possible to improve the folding endurance of the two-layer flexible printed wiring board. In other words, this is conceivably because the concerned deposition surface has a surface smoother than those of common low-profile electro-deposited copper foils, and hence the irregularities to be the positions of the tensile stress concentration and the compression stress concentration in performing folding endurance test are decreased to suppress the microcrack generation.

The characteristics of the low-profile copper foil as referred to herein are as follows. Conventional electro-deposited copper foils, having a non-roughened state, prepared by following the manufacturing methods disclosed in above-mentioned Patent Documents 3 and 4 each have given an average deposition-surface roughness (Rzjis) at a level exceeding 1.5 μm. On the contrary, as shown in Examples, the electro-deposited copper foil according to the present invention can attain a low profile of 0.6 μm or less in the surface roughness (Rzjis) of the deposition surface by optimizing the conditions. Here, no particular constraint is imposed on the lower limit of the roughness, but the lower limit of the roughness is empirically of the order of 0.1 μm.

The use of the glossiness, as an index for indicating the smoothness of the deposition surface of the electro-deposited copper foil to be used in manufacturing the two-layer flexible printed wiring board according to the present invention, makes it possible to clearly identify the difference from the conventional low-profile electro-deposited copper foils. In the glossiness measurement used in the present invention, the measurement light was made incident on the surface and along the machine direction (MD direction) of the electro-deposited copper foil at an incident angle of 60° C., and the intensity of the reflected light at a reflection angle of 60° was measured by using a glossmeter, VG-2000, manufactured by Nippon Denshoku Industries Co., Ltd. on the basis of the glossiness measurement method, JIS Z 8741-1997. The results thus obtained are as follows. The 12 μm thick conventional electro-deposited copper foils prepared by following the manufacturing methods disclosed in above-mentioned Patent Documents 3 and 4 each have given a measured glossiness (Gs(60°)) of the deposition surface to fall within a range approximately from 250 to 380. On the contrary, the electro-deposited copper foil according to the present invention has given a glossiness (Gs(60°)) exceeding 400, showing that the surface is smoother. Here, no constraint is also imposed on the upper limit of the glossiness, but the upper limit is empirically seemed to be of the order of 780.

The electro-deposited copper foil to be used for manufacturing the two-layer flexible printed wiring board according to the present invention has high mechanical properties such that the tennsile strength as received is 33 kgf/mm² or more , preferably 37 kgf/mm² or more and the tensile strength after heating (180° C.×60 min in the ambient atmosphere) is 30 kgf/mm² or more , preferably 33 kgf/mm² or more. Most of the 12 μm thick conventional electro-deposited copper foils prepared by following the manufacturing methods disclosed in above-mentioned Patent Documents 3 and 4 each exhibit physical properties such that the measured tensile strength is less than 33 kgf/mm² and the tensile strength after heating (180° C.×60 min in the ambient atmosphere) is 30 kgf/mm² under. As revealed from such tensile strengths, some of the conventional electro-deposited copper foils each have an tennsile strength as received not large in value, and are softened so as to each have a tensile strength of the order of 20 kgf/mm² only by heating of 180° C.×60 minutes in the standard heating process for forming a printed wiring board, manifesting themselves to be unsuitable for TAB (Three layer type) products requiring flying lead formation. Thus, it can be said that such conventional electro-deposited copper foils tend to be easily fractured when they have been once heated and are thereafter exerted by a tensile stress. On the contrary, the electro-deposited copper foil according to the present invention has high mechanical properties such that the tennsile strength as received is 33 kgf/mm² or more and the tensile strength after heating (180° C.×60 min in the ambient atmosphere) is 30 kgf/mm² or more. Further, as shown in Examples, the electro-deposited copper foil according to the present invention can attain high mechanical properties such that the tennsile strength as received is 38 kgf/mm² or more and the tensile strength after heating (180° C.×60 min in the ambient atmosphere) is 35 kgf/mm² or more by optimizing the conditions. Accordingly, the electro-deposited copper foil according to the present invention is applicable not only to COF tapes but to inner leads (flying leads) to be IC chip mounting portions of TAB(Three layer type) tapes having device holes.

Further, the electro-deposited copper foil to be used for manufacturing the two-layer flexible printed wiring board according to the present invention has satisfactory mechanical properties such that the elongation as received is 5% or more and the elongation after heating (180° C.×60 min in the ambient atmosphere) is 8% or more. Most of the 12 μm thick electro-deposited copper foils prepared by following the manufacturing methods disclosed in above-mentioned Patent Documents 3 and 4 each followed by being subjected to measurement of tensile-strength exhibit physical properties such that the elongation as received is less than 5% and the elongation after heating (180° C.×60 min in the ambient atmosphere) is less than 7%. Admittedly, even such order of magnitude elongations are sufficient to play a preventive role against foil cracking in processing into a rigid printed wiring board and through-hole formation by mechanical drilling. However, such order of magnitude elongations are insufficient to play a preventive role against crack generation in a wiring portion undergoing folding under use in a folded form of a two-layer flexible printed wiring board wherein the two-layer flexible printed wiring board is formed by adhering such an electro-deposited copper foil to a flexible base materials such as a polyimide film, a polyimideamide film, a polyester film, a polyphenylenesulfide film, a polyetherimide film, a fluororesin film, a liquid crystal polymer film. The electro-deposited copper foil to be used in the two-layer flexible printed wiring board according to the present invention has satisfactory mechanical properties such that the elongation as received is 5% or more and the elongation after heating (180° C.×60 min in the ambient atmosphere) is 8% or more, and hence can attain an elongation sufficient to endure the folding of the two-layer flexible printed wiring board.

For the electro-deposited copper foil to be used for manufacturing the two-layer flexible printed wiring board according to the present invention, most suitable is an electro-deposited copper foil which is obtained by electrolyzing a sulfuric acid-containing copper electro-deposited solution that is made to contain a quaternary ammonium salt polymer, namely, diallyldimethylammonium chloride.

Here, description is made on the electrolysis method in which electrolysis is carried out in a sulfuric acid-containing copper electro-deposited solution that is made to contain a quaternary ammonium salt polymer having a cyclic structure, namely, diallyldimethylammonium chloride. It is more preferable to use a sulfuric acid-containing copper electro-deposited solution obtained by adding the quaternary ammonium salt polymer having a cyclic structure, namely, diallyldimethylammonium chloride, 3-mercapto-1-propanesulfonic acid and chlorine. The use of a sulfuric acid-containing copper electro-deposited solution having such a composition makes it possible to stably manufacture the low-profile electro-deposited copper foil to be used in the present invention. The presence of 3-mercapto-1-propanesulfonic acid, the quaternary ammonium salt polymer having a cyclic structure and chlorine in the sulfuric acid-containing copper electro-deposited solution is most preferable, and the lack of any of these components causes an unstable manufacturing provide of the low-profile electro-deposited copper foil.

The concentration of 3-mercapto-1-propanesulfonic acid, in the sulfuric acid-containing copper electro-deposited solution to be used for manufacturing the electro-deposited copper foil that is to be used for manufacturing the two-layer flexible printed wiring board according to the present invention, is preferably 3 ppm to 50 ppm, more preferably 4 ppm to 30 ppm, and furthermore preferably 4 ppm to 25 ppm. When the concentration of 3-mercapto-1-propanesulfonic acid is less than 3 ppm, the deposition surface of the electro-deposited copper foil becomes rough to make it difficult to obtain a low-profile electro-deposited copper foil. On the other hand, also when the concentration of 3-mercapto-1-propanesulfonic acid exceeds 50 ppm, the effect to make flat and smooth the deposition surface of the electro-deposited copper foil obtained is not improved, but rather the electrode position condition is unstabilized. It is to be noted that the term, 3-mercapto-1-propanesulfonic acid, as referred to in the present invention is used in a sense that it includes the salts of 3-mercapto-1-propanesulfonic acid, the described concentration being given in terms of the sodium salt, namely, sodium3-mercapto-1-propanesulfonate. It is to be noted that the concentration of 3-mercapto-1-propanesulfonic acid means the concentration including the substances modified in the electro-deposited solution such as the dimmer of 3-mercapto-1-propanesulfonic acid as well as 3-mercapto-1-propanesulfonic acid.

The concentration of the quaternary ammonium salt polymer, in the sulfuric acid-containing copper electro-deposited solution to be used for manufacturing the electro-deposited copper foil that is to be used for manufacturing the two-layer flexible printed wiring board according to the present invention, is preferably 1 ppm to 50 ppm, more preferably 2 ppm to 30 ppm, and furthermore preferably 3 ppm to 25 ppm. As the quaternary ammonium salt polymer, various polymers can be used; however, in consideration of the effect to form a low-profile deposition surface, it is most preferable to use a compound in which the quaternary ammonium nitrogen atom is included as apart of a 5-membered ring structure, in particular, diallyldimethylammonium chloride.

The concentration of this diallyldimethylammonium chloride in the sulfuric acid-containing copper electro-deposited solution is, in consideration of the relation to the above-mentioned concentration of 3-mercapto-1-propanesulfonic acid, preferably 1 ppm to 50 ppm, more preferably 2 ppm to 30 ppm and furthermore preferably 3 ppm to 25 ppm. When the concentration of diallyldimethylammonium chloride in the sulfuric acid-containing copper electro-deposited solution is less than 1 ppm, the deposition surface of the electro-deposited copper foil becomes rough with any elevated concentration of 3-mercapto-1-propanesulfonic acid, and thus it becomes difficult to obtain a low-profile electro-deposited copper foil. Also when the concentration of diallyldimethylammonium chloride in the sulfuric acid-containing copper electro-deposited solution exceeds 50 ppm, the deposition condition of copper becomes unstable, and thus it becomes difficult to obtain a low-profile electro-deposited copper foil.

Further, the concentration of chlorine in the above-mentioned sulfuric acid-containing copper electro-deposited solution is preferably 5 ppm to 60 ppm and more preferably 10 ppm to 20 ppm. When the chlorine concentration is less than 5 ppm, the deposition surface of the electro-deposited copper foil becomes rough and the low profile cannot be maintained. On the other hand, when the chlorine concentration exceeds 60 ppm, the deposition surface of the electro-deposited copper foil becomes rough, the electrode position condition is not stabilized, and thus no low-profile deposition surface can be formed.

As described above, the component balance between 3-mercapto-1-propanesulfonic acid, diallyldimethylammonium chloride and chlorine in the sulfuric acid-containing copper electro-deposited solution is most essential; when the quantitative balance between these deviates from the above-mentioned ranges, the deposition surface of the electro-deposited copper foil becomes rough as a result, and the low profile cannot be maintained.

It is to be noted that the copper concentration and the free sulfuric acid concentration in the sulfuric acid-containing copper electrolyte solution, as referred to in the present invention, are assumed to be approximately 50 g/l to 120 g/l and 60 g/l to 250 g/l, respectively.

When the electro-deposited copper foil is manufactured by using the above-mentioned sulfuric acid-containing copper electrolyte solution, it is preferable to electrolyze by setting the solution temperature at 20° C. to 60° C. and the current density at 30 A/dm² to 90 A/dm². The solution temperature is 20° C. to 60° C. and more preferably 40° C. to 55° C. When the solution temperature is lower than 20° C., the deposition rate is degraded to result in large variations of the mechanical properties such as the elongation and the tensile strength. On the other hand, when the solution temperature exceeds 60° C., the evaporated water amount is increased to induce a rapid variation of the solution concentration, and the deposition surface of the electro-deposited copper foil thus obtained cannot maintain a satisfactory flat smoothness. The current density is 30 A/dm² to 90 A/dm² and more preferably 40 A/dm² to 70 A/dm². When the current density is less than 30 A/dm², the deposition rate of copper is small and the industrial productivity becomes poor. On the other hand, when the current density exceeds 90 A/dm², the roughness of the deposition surface of the obtained electro-deposited copper foil is increased, and hence no low-profile copper foil superior to conventional low-profile copper foils can be obtained.

The electro-deposited copper foil to be used for manufacturing the two-layer flexible printed wiring board according to the present invention can also be used as an electro-deposited copper foil, the deposition surface of which is subjected to at least one surface treatment of a roughening treatment, an passivation treatment and a silane coupling agent treatment.

Here, as the roughening treatment, there is adopted a method in which fine metal particles are formed to be adhered to the surface of the electro-deposited copper foil or a method in which a roughened surface is formed by etching. As the former method for forming and adhering fine metal particles, here is illustrated a method in which copper fine particles are formed to be adhered to the deposition surface. This roughening treatment step is composed of a step of depositing and adhering copper fine particles onto the deposition surface of the electro-deposited copper foil and, if needed, a step of carrying out a coating plating to prevent the exfoliation of the fine copper particles.

In the step of depositing fine copper particles to be adhered to the deposition surface of the electro-deposited copper foil, the burnt plating conditions are adopted as the electrolysis conditions. Accordingly, the concentration of the solution to be used in a step of generally depositing fine copper particles to be adhered is made to be low so as for the burnt plating conditions to be easily created. However, the electro-deposited copper foil to be used in the present invention has the deposition surface that is flat and low in profile in the same or higher degrees as compared to conventional low-profile copper foils, and hence, if burnt plating is applied, current concentration portions such as physical protrusions are scarce, thus making it possible to attain the formation of fine copper particles to be adhered in an extremely fine and uniform manner. The burnt plating conditions are not particularly limited, but are determined in consideration of the characteristics of the production line.

The step of carrying out a coating plating to prevent the exfoliation of the fine copper particles is a step in which, for the purpose of preventing the exfoliation of the electro-deposited and adhered fine copper particles, copper is electro-deposited uniformly to cover the fine copper particles under the smooth plating conditions. Accordingly, the same solution as used in the above-mentioned bulk copper formation vessel can be used as the copper ion supply source. The smooth plating conditions are not particularly limited, but are determined in consideration of the characteristics of the production line.

Next, description is made on the method for forming an passivation treatment layer. The passivation treatment layer serves as a preventive layer against the oxidative corrosion of the surface of the electro-deposited copper foil for the purpose of avoiding troubles in the course of manufacturing a flexible copper clad laminate and a flexible printed wiring board. The method used for the passivation treatment can adopt, without causing any problem, either an organic passivation treatment using benzotriazole, imidazole or the like or an inorganic passivation treatment using zinc, a chromate, a zinc alloy or the like. An passivation treatment may be selected according to the application purpose of the electro-deposited copper foil.

It is also preferable to constitute the passivation treatment layer and a chromate layer to be described later. The presence of the chromate layer improves the corrosion resistance, and simultaneously, the adhesiveness to the resin layer is also improved. For the chromate layer formation in this case, either a substitution method or an electro-deposited method may be adopted in a manner following the usual way.

The silane coupling agent treatment means a treatment to chemically improve the adhesiveness to the insulating layer constituting material after the completion of the roughening treatment, the passivation treatment and the like. The silane coupling agent, as referred to herein, to be used for the silane coupling agent treatment is not needed to be particularly limited, but can be optionally selected to be used from an epoxy silane coupling agent, an amino silane coupling agent, a mercapto silane coupling agent and the like, in consideration of the properties of the material constituting the insulating layer, the plating solution to be used in the manufacturing steps of the flexible printed wiring board and the like.

More specifically, vinyltrimethoxysilane, vinylphenyltrimethoxysilane and the like can be used with a focus on the same coupling agents as those used for glass cloth in the prepregs for use in printed wiring boards.

The surface treated copper foil obtained by applying the above-mentioned desired surface treatment (an optional combination of the roughening treatment and the passivation treatment) to the deposition surface can be made so as for the surface thereof, to be adhered to the resin film base material, to have a low profile of 5 μm or less in the surface roughness (Rzjis). In particular, when ultrafine copper particles, not requiring the above-mentioned coating plating, are formed to be adhered to the above surface treated copper foil, the surface thereof, to be adhered to the resin film base material, is made to have a low profile of 2 μm or less in the surface roughness (Rzjis). Even such a low-profile roughened surface can drastically improve the folding endurance through ensuring a satisfactory adhesiveness and preventing the peeling in folding between the roughened surface and the resin film base material, when adhered to the resin film layer. At the same time, a satisfactory etching performance can be ensured, and the heat resistance, the chemical resistance and the peeling strength, practically free from troubles as the two-layer flexible printed wiring board, can be obtained.

No particular constraint is imposed on the method for manufacturing the above described two-layer flexible copper clad laminate obtained by adhering the electro-deposited copper foil and the resin film. Any of the methods well known in the art may be adopted. In other words, when a casting method is used, a polyimide varnish is directly coated on the deposition surface of the above-mentioned electro-deposited copper foil by means of a coating device well known in the art such as a die coater, a roll coater, a rotary coater, a knife coater and a doctor blade, and thereafter the varnish is heated and dried to provide the two-layer flexible copper clad laminate. The polyimide varnish to be used here is not needed to be specially limited. In general, a polyamic acid varnish obtained by reacting a diamine reagent and an acid an hydride with each other, a polyimide resin varnish obtained by imidization of a polyamic acid through a chemical reaction or heating in a state of a solution, and the like can be widely used. Specifically, the acid anhydride can be appropriately selected from the viewpoint of the component as long as a polyimide resin having the desired composition can be obtained by heating and drying; trimellitic anhydride, pyromellitic dianhydride, biphenyltetracarboxylic dianhydride, benzophenonetetracarboxylic dianhydride and the like are used, without needing any particular constraint to be imposed on the acid anhydride. As the diamine reagent, phenylene diamine, diaminodiphenylmethane, diaminodiphenylsulfone, diaminodiphenylether and the like can be used each alone or in appropriate combinations of two or more thereof. It is to be clearly stated that, as long as these varnishes satisfy the required qualities when used in flexible printed wiring boards, these varnishes include polyimide composite varnishes added with resins such as a polyamideimide resin, a bismaleimide resin, a polyamide resin, an epoxy resin and an acrylic resin.

Step B: In this step of removing an initial-deposition crystal layer, by half-etching the shiny surface of the electro-deposited copper foil located on the surface of the two-layer flexible copper clad laminate, the initial-deposition crystal layer of the electro-deposited copper foil is removed and the steady-deposition crystal layer of the electro-deposited copper foil is thereby exposed. By carrying out such a half etching, there is removed the initial-deposition crystal, tending to be the origin of the microcrack generation at the time of folding operation. At the same time, the half etching removes the irregularities transferred from the surface shape of the rotary cathode, decreases the surface roughness, and increases the glossiness. Conceivably, in this way, the irregularities to be the positions of the tensile stress concentration and the compression stress concentration are decreased in the folding endurance test and the microcrack generation is thereby decreased. Further, the surface on which the steady-deposition crystal layer is exposed is a surface smoother than the shiny surfaces of usual electro-deposited copper foils and is free from irregularities, and hence alleviates the diffuse reflection of the UV light when the etching resist pattern is exposed after forming an etching resist layer and accordingly overcomes the exposure blurring; thus, the formation of the resist pattern, excellent in resolution, for forming a fine pitch wiring is made possible.

It is to be noted that the half etching as referred to herein may use any etching method well known in the art, and is not particularly limited. For example, a ferric chloride-based etching solution, a copper chloride-based etching solution, a sulfuric acid-hydrogen peroxide-based aqueous etching solution or the like is used; the copper foil is soaked in such an etching solution in a form of a flexible copper clad laminate, or the above-mentioned etching solution is sprayed or showered to the surface of the copper layer; thus, the electro-deposited copper foil is uniformly dissolved to a desired thickness, and then a rinsing treatment and a drying treatment were carried out.

When the half etching in this step B is carried out, the initial-deposition crystal layer is removed, and the thickness of the electro-deposited copper foil is also regulated in such a way that the deviation between the neutral line of the sectional thickness of the flexible printed wiring board to be formed and the central line of the sectional thickness of the electro-deposited copper foil layer falls within a predetermined range.

Step C: In this step of forming a wiring, an etching resist layer is formed on the steady-deposition crystal layer, an etching resist pattern is exposed and developed to carry out wiring etching, and the etching resist is peeled off to provide a flexible printed wiring board.

No particular constraint is imposed on the method for processing from a flexible copper clad laminate to a flexible printed wiring board. The etching processing well known in the art can be adequately used. Therefore, detailed description for the concerned method is omitted. The flexible printed wiring board thus obtained is excellent in folding endurance and enables fine wiring. Accordingly, the flexible printed wiring board thus obtained is suitable for manufacturing a film carrier tape-shaped, high-folding ability flexible printed wiring board having a fine pitch wiring of 35 μm or less in wiring pitch, among flexible printed wiring boards.

A second manufacturing method is a manufacturing method in which the shiny surface of the electro-deposited copper foil is used as the surface to be adhered to the resin film layer. In other words, the second manufacturing method is a method for manufacturing a flexible printed wiring board by etching a flexible copper clad laminate formed by laminating a resin film layer and an electro-deposited copper foil, wherein the manufacturing method includes the following steps a to c. Here, it is to be clearly stated that these manufacturing steps may be carried out each as an independent batch process, or may be carried out in a continuous manufacturing line in which a sequence of steps are continuously arranged. Hereinafter, each of the steps is described.

Step a: In this step of removing the initial-deposition crystal layer, the initial-deposition crystal layer is removed by half-etching from the side of the shiny surface of an electro-deposited copper foil having a shiny surface and a deposition surface on the front side and the back side thereof, respectively. In this case, the removal of the initial-deposition crystal layer is carried out in a state of an electro-deposited copper foil, and can adopt the techniques such that the electro-deposited copper foil is soaked in the same etching solution as the above-mentioned solution to be used for half etching, or the concerned etching solution is sprayed or showered to the surface of the shiny surface. However, when the etching from the side of the deposition surface is not desired, it is preferable to apply a corrosion prevention treatment such that an etching resist layer is beforehand formed on the deposition side.

When the half etching in this step a is carried out, the initial-deposition layer is removed, and the thickness of the electro-deposited copper foil is also regulated in such a way that the deviation between the neutral line of the sectional thickness of the flexible printed wiring board to be formed and the central line of the sectional thickness of the electro-deposited copper foil layer falls within a predetermined range.

Step b: In this step of forming a laminate, a two-layer flexible copper clad laminate is formed by forming a resin film layer on the shiny surface from which the initial-deposition crystal layer has been removed. In other words, as compared to the first manufacturing method, a resin film layer is formed on the electro-deposited copper foil surface opposite to the surface in the first manufacturing method. The film formation method in this case is the same as that in the first manufacturing method, and hence the description thereon is omitted to avoid a duplicate description.

Step c: In this step of forming a wiring, an etching resist layer is formed on the deposition surface of the electro-deposited copper foil located on a surface of the flexible copper clad laminate, an etching resist pattern is exposed and developed to carry out wiring etching, and the etching resist is peeled off to provide a two-layer flexible printed wiring board. This step is the same as the step C in the first manufacturing method, and hence the description thereon is omitted to avoid a duplicate description.

The half etching in the step a removes the initial-deposition crystal layer, and also preferably regulates the thickness of the electro-deposited copper foil layer until the deviation between the neutral line of the sectional thickness of the flexible printed wiring board to be formed and the central line of the sectional thickness of the electro-deposited copper foil layer falls within a predetermined range.

The flexible printed wiring boards (folding endurance test sample) according to the present invention were prepared and subjected to a folding endurance test. The results thus obtained are presented below as Examples.

### EXAMPLE 1

Preparation of an electro-deposited copper foil: In this Example, by using, as a sulfuric acid-containing copper electro-deposited solution, a solution of copper sulfate in which the copper concentration was 80 g/l, the free sulfuric acid concentration was 140 g/l, the 3-mercapto-1-propanesulfonic acid concentration was 4 ppm, the diallyldimethylammonium chloride (Unisense FPA100L manufactured by Senka Co., Ltd. was used) concentration was 3 ppm, the chlorine concentration was 10 ppm, and the solution temperature was 50° C., electrolysis was carried out at a current density of 60 A/dm² to provide a 18 μm thick electro-deposited copper foil. One side of this electro-deposited copper foil was a shiny surface (Rzjis=1.02 μm) transferred from the surface shape of a titanium electrode, and the roughness of the deposition surface on the other side was such that Rzjis=0.53 μm and Ra=0.09 μm and the glossiness (Gs(60°)) was 669; and the tennsile strength as received was 39.9 kgf/mm², the tensile strength after heating was 35.2 kgf/mm², the elongation as received was 7.6% and the elongation after heating was 14.3%.

Only the passivation treatment was applied, as the surface treatment of the above-mentioned electro-deposited copper foil, to both sides including the concerned deposition surface. Here, as the inorganic passivation under the conditions described below, a zinc passivation layer was adopted. Further, in the case of this Example, a chromate layer was formed electro-deposited ally on the above-mentioned zinc passivation layer.

On completion of the passivation treatment as described above, rinsing with water was carried out, and immediately, γ-glycidoxypropyltrimethoxysilane was adsorbed on the passivation treatment layer of the surface subjected to passivation treatment.

On completion of the silane coupling agent treatment, the electro-deposited copper foil was finally made to pass, over a period of 4 seconds, through a furnace interior the atmosphere temperature of which was regulated by heating with an electric heater so as for the foil temperature to be 140° C., thus the moisture of the electro-deposited copper foil was removed, the condensation reaction of the silane coupling agent was promoted, and thus a completed electro-deposited copper foil was obtained. The thickness of the initial-deposition crystal layer of the electro-deposited copper foil layer was 3.7 μm on average.

Removal of the initial-deposition crystal layer of the electro-deposited copper foil: An etching resist layer was formed on the deposition surface of the above-mentioned electro-deposited copper foil, a copper chloride based etching solution was sprayed onto the shiny surface of the electro-deposited copper foil to remove the approximately 3.7 μm thick initial-deposition crystal layer, and etching was further continued so as for the electro-deposited copper foil to have a thickness of 9.8 μm. The etching resist layer formed on the deposition surface was swollen and removed with an alkaline solution, and sufficient rinsing was carried out.

Preparation of a flexible copper clad laminate: A commercially available polyimide precursor varnish that contained a polyamic acid solution was coated on the shiny surface, from which the initial-deposition crystal layer was removed, of the above-mentioned electro-deposited copper foil, and the imidization was carried out by heating, and thus a 39.5 μm thick polyimide resin film based on a casting method was formed. Consequently, there was prepared a two-layer flexible copper clad laminate (total thickness: 49.4 μm), having a film width of 35 mm, that was composed of an approximately 9.8 μm thick electro-deposited copper foil layer and a 39.6 μm thick polyimide resin film layer (base film layer).

Preparation of a sample for the folding endurance test: A wiring pattern was formed by means of a photolithography method on the above-mentioned flexible copper clad laminate, a displacement tin plating was carried out, and thus there was formed a folding endurance test wiring of 30 μm pitch wiring (wiring thickness after tin plating: 9.8 μm) within a dimension of 23 mm in width and 10 mm in length. In this case, the wiring formation direction of the sample concerned was made to correspond to the width direction (TD direction) of the electro-deposited copper foil preparation. Thereafter, as shown in FIG. 3, a 8.7 μm thick solder resist layer 3 was formed on the half of the region of the wiring 5 on the polyimide resin film layer 4, and thus a sample 6 was prepared. In this case, the total thickness of the flexible printed wiring board is 58.1 μm, and the neutral line thereof is located at a position 29.05 μm away from the bottom surface of the polyimide resin film layer. The central line of the wiring is located at a position 44.5 μm away from the bottom surface of the polyimide resin film layer. Accordingly, the deviation between the neutral line and the central line is 15.45 μm. Therefore, the ratio of the deviation to the total thickness is 15.45(μm)/58.1(μm)×100=26.59%.

Results of the folding endurance test: A predetermined number of times of folding (repeated folding) was carried out at the folding position 7 (the position where the solder resist layer 3 was present) shown in FIG. 3, and the fracture conditions of the wiring 5 were identified. Consequently, the average number of times of folding up to occurrence of fracture was 43.3 times in the case of R (0.5 mm) and 110.7 times in the case of R (0.8 mm). The detailed evaluation results thus obtained are shown in Table 1.

### EXAMPLE 2

Preparation of an electro-deposited copper foil: In this Example, the same electro-deposited copper foil as used in Example 1 was used.

Preparation of a flexible copper clad laminate: A commercially available polyimide precursor varnish that contained a polyamic acid solution was coated on the deposition surface of the above-mentioned electro-deposited copper foil, and the imidization was carried out by heating, and thus a 39.5 μm thick polyimide resin film based on a casting method was formed. Consequently, there was prepared a two-layer flexible copper clad laminate (total thickness: 57.5 μm) that was composed of an approximately 18 μm thick electro-deposited copper foil and a 39.5 μm thick polyimide resin film layer (base film layer).

Preparation of a sample for the folding endurance test: The above-mentioned flexible copper clad laminate was soaked in a copper chloride based etching solution to remove the approximately 3.7 μm thick initial-deposition crystal layer of the above-mentioned electro-deposited copper foil, and etching was further continued so as for the electro-deposited copper foil to have a thickness of 9.2 μm.

In the same manner as in Example 1, there was formed a folding endurance test wiring of 30 μm pitch wiring (wiring thickness after displacement tin plating: 9.2 μm). Thereafter, as shown in FIG. 3, a 8.6 μm thick solder resist layer 3 was formed on the half of the region of the wiring was prepared. In this case, the total thickness of the flexible printed wiring board is 57.3 μm, and the neutral line thereof is located at a position 28.65 μm away from the bottom surface of the polyimide resin film layer. The central line of the wiring 5 is located at a position 44.1 μm away from the bottom surface of the polyimide resin film layer. Accordingly, the deviation between the neutral line and the central line is 15.45 μm. Therefore, the ratio of the deviation to the total thickness is 15.45(μm)/57.3(μm)×100=26.96%.

Results of the folding endurance test: A predetermined number of times of folding (repeated folding) was carried out at the folding position 7 (the position where the solder resist layer 3 was present) shown in FIG. 3, and the fracture conditions of the wiring 5 were identified. Consequently, the average number of times of folding up to occurrence of fracture was 45.7 times in the case of R (0.5 mm) and 130.1 times in the case of R (0.8 mm). The detailed evaluation results thus obtained are shown in Table 1.

### EXAMPLE 3

In this Example, there was used a conventional, commercially available low-profile electro-deposited copper foil, namely, an approximately 18 μm thick low-profile copper foil manufactured by Mitsui Mining and Smelting Co., Ltd. One side of this electro-deposited copper foil was a shiny surface (Rzjis=1.05 μm) transferred from the surface shape of a titanium electrode, and the roughness of the deposition surface on the other side was such that Rzjis=0.85 μm and Ra=0.12 μm and the glossiness (Gs(60°)) was 60; and the tennsile strength as received was 51.4 kgf/mm², the tensile strength after heating was 48.7 kgf/mm², the elongation as received was 5.6% and the elongation after heating was 6.7%. It is to be noted that the thickness of the initial-deposition crystal layer of this electro-deposited copper foil was 8.5 μm on average.

Removal of the initial-deposition crystal layer of the electro-deposited copper foil: An etching resist layer was formed on the deposition surface of the above-mentioned electro-deposited copper foil, a copper chloride based etching solution was sprayed onto the shiny surface of the electro-deposited copper foil to remove the approximately 8.5 μm thick initial-deposition crystal layer, and etching was further continued so as for the electro-deposited copper foil to have a thickness of 8.1 μm. The etching resist layer formed on the deposition surface was swollen and removed with an alkaline solution, and sufficient rinsing was carried out.

Preparation of a flexible copper clad laminate: A commercially available polyimide precursor varnish that contained a polyamic acid solution was coated on the shiny surface, from which the initial-deposition crystal layer was removed, of the above-mentioned electro-deposited copper foil, and the imidization was carried out by heating, and thus a 38.9 μm thick polyimide resin film based on a casting method was formed. Consequently, there was prepared a two-layer flexible copper clad laminate (total thickness: 47.0 μm) that was composed of the 8.1 μm thick electro-deposited copper foil and a 38.9 μm thick polyimide resin film layer (base film layer).

Preparation of a sample for the folding endurance test: By using this flexible copper clad laminate, in the same manner as in Example 1, there was formed a folding endurance test wiring of 30 μm pitch wiring (wiring thickness after displacement tin plating: 8.1 μm), and further there was prepared a folding endurance measurement sample having a 8.1 μm thick solder resist layer. In this case, the total thickness of the flexible printed wiring board is 55.1 μm, and the neutral line thereof is located at a position 27.55 μm away from the bottom surface of the polyimide resin film layer. The central line of the wiring 5 is located at a position 42.95 μm away from the bottom surface of the polyimide resin film layer. Accordingly, the deviation between the neutral line and the central line is 15.4 μm. Therefore, the ratio of the deviation to the total thickness is 15.4(μm)/55.1(μm)×100=27.95%.

Results of the folding endurance test: A predetermined number of times of folding (repeated folding) was carried out at the folding position 7 (the position where the solder resist layer 3 was present) shown in FIG. 3, and the fracture conditions of the wiring 5 were identified. Consequently, the average number of times of folding up to occurrence of fracture was 23.8 times in the case of R (0.5 mm) and 57.3 times in the case of R (0.8 mm). The detailed evaluation results thus obtained are shown in Table 1.

### COMPARATIVE EXAMPLE 1

In this Comparative Example, there was used a two-layer flexible copper clad laminate in which a copper layer was formed on the surface of a polyimide resin film by means of a metallizing method. This two-layer flexible copper clad laminate is a product in which the thickness of the polyimide resin film is 37.8 μm and the thickness (inclusive of a seed layer) of the copper layer is 7.8 μm. By using this laminate, in the same manner as in Example 1, there was prepared a folding endurance measurement sample in which a 9.7 μm thick solder resist layer was formed on a wiring having a wiring thickness after displacement tin plating of 7.8 μm, and the sample was subjected to a folding endurance measurement.

In this case, the total thickness of the flexible printed wiring board is 55.3 μm, and the neutral line thereof is located at a position 27.65 μm away from the bottom surface of the polyimide resin film layer. The central line of the wiring is located at a position 41.7 μm away from the bottom surface of the polyimide resin film layer. Accordingly, the deviation between the neutral line and the central line is 14.05 μm. Therefore, the ratio of the deviation to the total thickness is 14.05(μm)/55.3(μm)×100=25.4%.

Results of the folding endurance test: A predetermined number of times of folding (repeated folding) was carried out at the folding position 7 (the position where the solder resist layer 3 was present) shown in FIG. 3, and the fracture conditions of the wiring 5 were identified. Consequently, the average number of times of folding up to occurrence of fracture was 33.4 times in the case of R (0.5 mm) and 104.5 times in the case of R (0.8 mm). The detailed evaluation results thus obtained are shown in Table 1.

### COMPARATIVE EXAMPLE 2

Preparation of an electro-deposited copper foil: In this Comparative Example, there was used a low-profile electro-deposited copper foil of approximately 12 μm in thickness, prepared in the same manner as in Example 1. One side of this electro-deposited copper foil was a shiny surface (Rzjis=1.02 μm) transferred from the surface shape of a titanium electrode, and the roughness of the deposition surface on the other side was such that Rzjis=0.51 μm and Ra=0.08 μm and the glossiness (Gs(60°)) was 670; and the tennsile strength as received was 38.7 kgf/mm², the tensile strength after heating was 35.5 kgf/mm², the elongation as received was 7.3% and the elongation after heating was 12.5%. The subsequent surface treatments such as the passivation treatment are the same as in Example 1. It is to be noted that the thickness of the initial-deposition crystal layer on the side of the shiny surface was approximately 4.0 μm.

Preparation of a flexible copper clad laminate: In the same manner as in Example 2, a polyimide resin film layer was formed on the deposition surface of the electro-deposited copper foil by means of a casting method. Consequently, there was prepared a two-layer flexible copper clad laminate that was composed of an approximately 12 μm thick electro-deposited copper foil and a 39.6 μm thick polyimide resin film layer (base film layer).

Preparation of a sample for the folding endurance test: The above-mentioned electro-deposited copper foil of the above-mentioned flexible copper clad laminate was subjected to etching at a level of acid treatment by using the same etching solution as in Example 1, for the only purpose of cleaning the surface thereof, and thus the initial-deposition crystal was removed by a thickness of approximately 2.0 μm. Consequently, there was obtained an approximately 10 μm thick electro-deposited copper foil layer in which an approximately 2.0 μm thick initial-deposition crystal layer was left. Hereinafter, in the same manner as in Example 2, there was prepared a folding endurance measurement sample in which a 8.7 μm thick solder resist layer was formed on a wiring having a thickness after displacement tin plating of 10 μm. In this case, the total thickness of the flexible printed wiring board is 58.3 μm, and the neutral line thereof is located at a position 29.15 μm away from the bottom surface of the polyimide resin film layer. The central line of the wiring is located at a position 44.6 μm away from the bottom surface of the polyimide resin film layer. Accordingly, the deviation between the neutral line and the central line is 15.45 μm. Therefore, the ratio of the deviation to the total thickness is 15.45(μm)/58.3(μm)×100=26.50%. In other words, the deviation between the neutral line and the central line was made to fall within an appropriate range.

Results of the folding endurance test: A predetermined number of times of folding (repeated folding) was carried out at the folding position 7 (the position where the solder resist layer 3 was present) shown in FIG. 3, and the fracture conditions of the wiring 5 were identified. Consequently, the average number of times of folding up to occurrence of fracture was 23.7 times in the case of R (0.5 mm) and 54.8 times in the case of R (0.8 mm). The detailed evaluation results thus obtained are shown in Table 1.

### COMPARATIVE EXAMPLE 3

This Comparative Example is an example in which a conventional two-layer flexible copper clad laminate, for use in fine pitch wiring, prepared by a casting method was used. Specifically, this Comparative Example adopted approximately the same process as adopted in Example 3, and hence duplicate descriptions are omitted, and only the facts unique to this Comparative Example are described. Fundamentally unique is the fact that the electro-deposited copper foil was used without removing the initial-deposition crystal layer. In other words, the commercially available low-profile copper foil used in Example 3 was not subjected to the removed of the initial-deposition crystal layer, and the following steps were carried out.

Preparation of a flexible copper clad laminate: A commercially available polyimide precursor varnish that contained a polyamic acid solution was coated on the shiny surface of the above-mentioned electro-deposited copper foil, and the imidization was carried out by heating, and thus a 39.7 μm thick polyimide resin film based on a casting method was formed. Consequently, there was prepared a two-layer flexible copper clad laminate (total thickness: 56.9 μm) that was composed of an approximately 18 μm thick electro-deposited copper foil and a 39.7 μm thick polyimide resin film layer (base film layer).

Preparation of a sample for the folding endurance test: The above-mentioned flexible copper clad laminate was soaked in a copper chloride based etching solution to regulate the thickness of the above-mentioned electro-deposited copper foil layer to be approximately 8.4 μm. The thickness of the initial-deposition crystal layer of the electro-deposited copper foil was 8.5 μm, and hence it is meant that almost the whole electro-deposited copper foil layer is constituted with the initial-deposition crystal layer.

By using this flexible copper clad laminate, in the same manner as in Example 1, there was formed a 30 μm pitch wiring subjected to displacement tin plating (wiring thickness after displacement tin plating: 8.4 μm), and further there was prepared a folding endurance measurement sample having a 9.7 μm thick solder resist layer. In this case, the total thickness of the flexible printed wiring board is 57.8 μm, and the neutral line thereof is located at a position 28.9 μm away from the bottom surface of the polyimide resin film layer. The central line of the wiring 5 is located at a position 43.9 μm away from the bottom surface of the polyimide resin film layer. Accordingly, the deviation between the neutral line and the central line is 15.0 μm. Therefore, the ratio of the deviation to the total thickness is 15.0(μm)/57.8(μm)×100=25.95%.

Results of the folding endurance test: A predetermined number of times of folding (repeated folding) was carried out at the folding position 7 (the position where the solder resist layer 3 was present) shown in FIG. 3, and the fracture conditions of the wiring 5 were identified. Consequently, the average number of times of folding up to occurrence of fracture was 17.3 times in the case of R (0.5 mm) and 26.7 times in the case of R (0.8 mm). The detailed evaluation results thus obtained are shown in Table 1.

TABLE 1
Table 1.

| Sample | | Ex. 1 | | Ex. 2 | | Ex. 3 | | Com. Ex. 1 | | Com. Ex. 2 | | Com. Ex. 3 | |
|---|---|---|---|---|---|---|---|---|---|---|---|---|---|
| Test | Formation method | Casting | | Casting | | Casting | | Metallizing | | Casting | | Casting | |
| sample | of polyimide resin | method | | method | | method | | method | | method | | method | |
| | layer | | | | | | | | | | | | |
| | Formation | Shiny | | Deposition | | Shiny | | — | | Deposition | | Shiny | |
| | position of | surface of | | surface of | | surface of | | | | of surface | | of surface | |
| | polyimide resin | electro-deposited | | electro-deposited | | electro-deposited | | | | electro-deposited | | electro-deposited | |
| | layer | copper foil | | copper foil | | copper foil | | | | copper foil | | copper | |
| | | | | | | | | | | | | foil | |
| | Wiring thickness | 9.8 | | 9.2 | | 8.1 | | 7.8 | | 10.0 | | 8.4 | |
| | (μm) | | | | | | | | | | | | |
| | Polyimide resin | 39.6 | | 39.5 | | 38.9 | | 37.8 | | 39.6 | | 39.7 | |
| | layer thickness | | | | | | | | | | | | |
| | (μm) | | | | | | | | | | | | |
| | Solder resist | 8.7 | | 8.6 | | 8.1 | | 9.7 | | 8.7 | | 9.7 | |
| | thickness (μm) | | | | | | | | | | | | |
| Wiring for | Wiring pitch (μm) | 30 | | | | | | | | | | | |
| folding | Lead bottom line | 14.2 | | 14.7 | | 3.8 | | 16.2 | | 14.5 | | 14.6 | |
| endurance | width (μm) | | | | | | | | | | | | |
| test | Folding direction | TD direction | | | | | | MD direction | | TD direction | | | |
| Folding | Load (g) | 100 | | | | | | | | | | | |
| ability | Folding position | On the solder resist | | | | | | | | | | | |
| evaluation | R (mm) | 0.5 | 0.8 | 0.5 | 0.8 | 0.5 | 0.8 | 0.5 | 0.8 | 0.5 | 0.8 | 0.5 | 0.8 |
| conditions | | | | | | | | | | | | | |
| Folding | 1 | 45 | 128 | 46 | 103 | 23 | 60 | 30 | 121 | 23 | 61 | 17 | 29 |
| endurance | 2 | 34 | 107 | 45 | 122 | 18 | 57 | 39 | 113 | 22 | 53 | 12 | 20 |
| test | 3 | 46 | 110 | 52 | 128 | 26 | 58 | 35 | 105 | 25 | 47 | 14 | 29 |
| results | 4 | 34 | 112 | 38 | 127 | 20 | 53 | 42 | 93 | 18 | 66 | 12 | 29 |
| (times) | 5 | 36 | 123 | 54 | 139 | 25 | 49 | 26 | 105 | 30 | 42 | 18 | 32 |
| | 6 | 48 | 118 | 32 | 139 | 25 | 51 | 27 | 114 | 31 | 72 | 20 | 33 |
| | 7 | 43 | 107 | 37 | 140 | 26 | 61 | 36 | 93 | 23 | 50 | 16 | 28 |
| | 8 | 50 | 95 | 57 | 145 | 21 | 69 | 28 | 106 | 17 | 61 | 23 | 23 |
| | 9 | 41 | 94 | 52 | 131 | 26 | 63 | 31 | 98 | 20 | 45 | 19 | 23 |
| | 10 | 57 | 113 | 44 | 127 | 28 | 52 | 40 | 97 | 28 | 51 | 22 | 21 |
| | Ave. | 43.4 | 110.7 | 45.7 | 130.1 | 23.8 | 57.3 | 33.4 | 104.5 | 23.7 | 54.8 | 17.3 | 26.7 |
| | Max. | 57 | 128 | 57 | 145 | 28 | 69 | 42 | 121 | 31 | 72 | 23 | 33 |
| | Min. | 34 | 94 | 32 | 103 | 18 | 49 | 26 | 93 | 17 | 42 | 12 | 20 |

### COMPARISON OF EXAMPLES WITH COMPARATIVE EXAMPLES

The results obtained from a comparison between Examples and Comparative Examples are described with reference to Table 1.

Comparison of Example 1 with Comparative Examples: The folding endurance test performance of Example 1 is compared with those of respective Comparative Examples. First, a comparison with Comparative Examples 2 and 3 in each of which the initial-deposition crystal remained within the wiring constituting the wiring shows that Example 1 obtained far higher folding endurance test results.

As can be seen from a comparison with a commercially available sample (Comparative Example 1) in which the copper layer was formed by a metallizing method, Example 1 attained a comparable performance and approached the properties obtained by use of a rolled copper foil.

Comparison of Example 2 with Comparative Examples: Before a comparison between Example 2 with Comparative Examples, a comparison between Example 1 and Example 2 is carried out. In Example 1, there was used, as the surface to adhere to the polyimide resin layer, the shiny surface from which the initial-deposition crystal layer of the electro-deposited copper foil was removed. On the contrary, in Example 2, the deposition surface of the electro-deposited copper foil was used as the polyimide resin layer, and the initial-deposition crystal layer located on the shiny surface opposite to the deposition surface was removed. In view of the folding endurance test results of Examples 1 and 2, the folding endurance test results of Example 2 are better. In other words, it can be determined that it is preferable to use the deposition surface of the electro-deposited copper foil as the surface to adhere to the polyimide resin layer.

As can be seen from a comparison of the folding endurance test results of Example 2 with those of Comparative Example 1, Examples 2 exhibits a satisfactory folding endurance at a level exceeding Comparative Example 1.

Further, as can be clearly seen from a comparison of Example 2 with Comparative Example 2, only the remaining of the initial-deposition crystal in a part of the copper layer constituting the wiring remarkably degrades the folding endurance.

Comparison of Example 3 with Comparative Examples: This Example 3 is to be mainly compared with Comparative Example 3, but, at the beginning, Example 3 is compared with other Examples. When the folding endurance of Example 3 is compared with those of Examples 1 and 2, the folding endurances of Examples 1 and 2 are clearly superior to that of Example 3. This fact clearly shows that even when no initial-deposition crystal is present in the formed wiring, the crystal properties intrinsically belonging to the electro-deposited copper foil greatly affect the folding endurance.

However, as can be seen from a comparison of Example 3 with Comparative Example 3, although both of Example 3 and Comparative Example 3 used the same type of electro-deposited copper foil, the presence/absence of the initial-deposition crystals in the formed wiring created the clear difference in the folding endurance.

As can be said from the above described comparisons between Examples and Comparative Examples, when the electro-deposited copper foils are of the same type, the wiring formation after the removal of the initial-deposition crystal layer can attain the improvement of the folding endurance. As can be understood, a highly reliable folding endurance comparable to that obtainable by using a rolled copper foil can be obtained by obtaining a flexible printed wiring board on the basis of the appropriate selection of the electro-deposited copper foil according to the folding endurance required as a flexible printed wiring board product, and on the basis of the manufacture of a flexible copper clad laminate in which the electro-deposited copper foil from which the initial-deposition crystal layer is removed by means of a desired method and a resin film base material are laminated with each other.

### INDUSTRIAL APPLICABILITY

The flexible printed wiring board according to the present invention has a characteristic that it dose not include any initial-deposition crystal layer, formed at the time of preparation of an electro-deposited copper foil, in the copper wiring formed by etching the electro-deposited copper foil. Owing to the presence of this characteristic, the folding endurance of the flexible printed wiring board according to the present invention becomes satisfactory, and approaches the folding endurance obtainable when a rolled copper foil is used, without raising the product cost. Accordingly, the use of such a flexible copper clad laminate is to be expanded in those fields where no electro-deposited copper foils have hitherto been used, but rolled foils or flexible copper clad laminates made by Metallizing method have been used. When the flexible printed wiring board according to the present invention is manufactured, assumed is the application of an electro-deposited copper foil that is further lower in profile than conventional low-profile electro-deposited copper foils and has mechanical physical properties including a high mechanical strength. Thus, the flexible printed wiring board according to present invention is suitable for forming fine pitch wirings of tape automated bonding (TAB:Three layer type) tape and chip-on-film (COF) tape, having a wiring pitch of 35 μm or less.

What is claimed is:

1. A two-layer flexible printed wiring board having a wiring, formed by etching an electro-deposited copper foil, on a surface of a resin film layer,
the wiring comprising only a steady-deposition crystal layer formed by removing an initial-deposition crystal layer formed at the time of the electro-deposited copper foil preparation.

2. The two-layer flexible printed wiring board according to claim 1, having a cover film layer, wherein:
the deviation between the neutral line of the sectional thickness of the two-layer flexible printed wiring board and the central line of the wiring thickness of the two-layer flexible printed wiring board falls within 5% of the total thickness of the two-layer flexible printed wiring board.

3. The two-layer flexible printed wiring board according to claim 1, having a solder resist layer, wherein:
the deviation between the neutral line of the sectional thickness of the two-layer flexible printed wiring board and the central line of the wiring thickness of the two-layer flexible printed wiring board is 20% to 30% of the total thickness of the two-layer flexible printed wiring board.

4. The two-layer flexible printed wiring board according to claim 1, wherein the two-layer flexible printed wiring board is of a film carrier tape in which the formed wiring has a fine-pitch wiring of 35 μm or less in pitch.

5. A method for manufacturing the two-layer flexible printed wiring board according to claim 1, in which a two-layer flexible printed wiring board is manufactured by etching a two-layer flexible copper clad laminate formed by laminating a resin film layer and an electro-deposited copper foil, the method comprising the following steps A to C:
step A: a step of forming a flexible copper clad laminate by providing a resin film layer on the deposition surface of an electro-deposited copper foil having a shiny surface and a deposition surface on the front side and the back side thereof, respectively;
step B: a step of removing an initial-deposition crystal layer of the electro-deposited copper foil by half-etching the shiny surface of the electro-deposited copper foil located on the surface of the flexible copper clad laminate to expose a steady-deposition crystal layer of the electro-deposited copper foil; and
step C: a step of forming a wiring by forming an etching resist layer on the steady-deposition crystal layer, exposing and developing an etching resist pattern, carrying out wiring etching, and stripping the etching resist to provide a two-layer flexible printed wiring board.

6. The method for manufacturing the two-layer flexible printed wiring board according to claim 5, wherein the half etching in the step B removes the initial-deposition crystal layer and also regulates the thickness of the electro-deposited copper foil layer so that the deviation between the neutral line of the sectional thickness of the flexible printed wiring board to be formed and the central line of the sectional thickness of the electro-deposited copper foil layer may fall within a predetermined range.

7. A method for manufacturing the two-layer flexible printed wiring board according to claim 1, in which a two-layer flexible printed wiring board is manufactured by etching a two-layer flexible copper clad laminate formed by laminating a resin film layer and an electro-deposited copper foil, the method comprising the following steps a to c:
step a: a step of removing an initial-deposition crystal layer by half-etching from the side of the shiny surface of an electro-deposited copper foil having a shiny surface and a deposition surface on the front side and the back side thereof, respectively;
step b: a step of forming a two-layer flexible copper clad laminate by providing a resin film layer on the shiny surface from which the initial-deposition crystal layer has been removed; and
step c: a step of forming a wiring by forming an etching resist layer on the deposition surface of the electro-deposited copper foil located on a surface of the flexible copper clad laminate, exposing and developing an etching resist pattern, carrying out wiring etching, and stripping the etching resist to provide a two-layer flexible printed wiring board.

8. The method for manufacturing the two-layer flexible printed wiring board according to claim 7, wherein the half etching in the step a removes the initial-deposition crystal layer and also regulates the thickness of the electro-deposited copper foil layer so that the deviation between the neutral line of the sectional thickness of the flexible printed wiring board to be formed and the central line of the sectional thickness of the electro-deposited copper foil layer may fall within a predetermined range.

9. The method for manufacturing the two-layer flexible printed wiring board according to claim 5, wherein the electro-deposited copper foil used has a deposition surface which is a low-profile shiny surface having a surface roughness (Rzjis) of 1.5 μm or less and a glossiness (Gs(60°)) of 400 or more.

10. The method for manufacturing the two-layer flexible printed wiring board according to claim 7, wherein the electro-deposited copper foil used has a deposition surface which is a low-profile shiny surface having a surface roughness (Rzjis) of 1.5 μm or less and a glossiness (Gs(60°)) of 400 or more.

11. The method for manufacturing the two-layer flexible printed wiring board according to claim 5, wherein the electro-deposited copper foil used has an tennsile strength as received of 33 kgf/mm² or more and a tensile strength after heating (180° C.×60 min the ambient atmosphere) of 30 kgf/mm² or more.

12. The method for manufacturing the two-layer flexible printed wiring board according to claim 7, wherein the electro-deposited copper foil used has an tennsile strength as received of 33 kgf/mm² or more and a tensile strength after heating (180° C.×60 min the ambient atmosphere) of 30 kgf/mm² or more.

13. The method for manufacturing the two-layer flexible printed wiring board according to claim 5, wherein the electro-deposited copper foil used has an elongation as received of 5% or more and an elongation after heating (180° C.×60 min in the ambient atmosphere) of 8% or more.

14. The method for manufacturing the two-layer flexible printed wiring board according to claim 7, wherein the electro-deposited copper foil used has an elongation as received of 5% or more and an elongation after heating (180° C.×60 min in the ambient atmosphere) of 8% or more.

15. The method for manufacturing the two-layer flexible printed wiring board according to claim 5, wherein the electro-deposited copper foil used is obtained by electrolyzing a sulfuric acid-containing copper electro-deposited solution containing diallyldimethylammonium chloride as a quaternary ammonium salt polymer.

16. The method for manufacturing the two-layer flexible printed wiring board according to claim 7, wherein the electro-deposited copper foil used is obtained by electrolyzing a sulfuric acid-containing copper electro-deposited solution containing diallyldimethylammonium chloride as a quaternary ammonium salt polymer.

17. The method for manufacturing the two-layer flexible printed wiring board according to claim 5, wherein the electro-deposited copper foil used has a deposition surface subjected to at least one surface treatment of a roughening treatment, an passivation treatment and a silane coupling agent treatment.

18. The method for manufacturing the two-layer flexible printed wiring board according to claim 7, wherein the electro-deposited copper foil used has a deposition surface subjected to at least one surface treatment of a roughening treatment, an passivation treatment and a silane coupling agent treatment.

19. The method for manufacturing the two-layer flexible printed wiring board according to claim 17, wherein the electro-deposited copper foil used has a low profile deposition surface having a surface roughness (Rzjis) of 5 μm or less after the surface treatment.

20. The method for manufacturing the two-layer flexible printed wiring board according to claim 18, wherein the electro-deposited copper foil used has a low profile deposition surface having a surface roughness (Rzjis) of 5 μm or less after the surface treatment.
